(19) United States
(12) Patent Application Publication
(10) Pub. No.: US 2013/0170920 A1
(43) Pub. Date: Jul. 4, 2013

(54) DRILL AND METHOD OF MANUFACTURING MACHINED PRODUCT USING THE SAME

(71) Applicant: Hiroshi Ogawa, Oumihachiman-shi (JP)

(72) Inventor: Hiroshi Ogawa, Oumihachiman-shi (JP)

(73) Assignee: KYOCERA CORPORATION, Kyoto (JP)

(21) Appl. No.: 13/821,841

(22) PCT Filed: Jan. 31, 2012
(86) PCT No.: PCT/JP2012/052125

§ 371 Date: Mar. 8, 2013

(30) Foreign Application Priority Data
Jan. 31, 2011 (JP) 2011-018306

(51) Int. Cl. B23B 51/02

(52) U.S. Cl. CPC B23B 51/02
USPC 408/1 R; 408/230

(57) ABSTRACT

A drill according to an embodiment of the present invention includes a body part and a cutting part with a cylinder-like shape. The cutting part includes two cutting edges located separately from each other at a front end portion of the cutting part, two flutes which are continuous with each of the two cutting edges and extend spirally toward a rear end portion of the cutting part, and a clearance which extends spirally from a side of the front end portion to a side of the rear end portion, and is recessed inward in reference to a periphery of the cutting part in a sectional view. The cutting part includes a first joining flute including at least one of the two flutes and the clearance being joined together. The first joining flute includes a bottom surface being outwardly protruding curve-like line in a sectional view. A method of manufacturing a machined product using the drill is also provided.

### TECHNICAL FIELD

The present invention relates to a drill and a method of manufacturing a machined product using the drill.

### BACKGROUND ART

Heretofore, for example, Japanese Unexamined Patent Publication No. 2007-307642 discloses a drill having, on the front end of a body thereof, two cutting edges and two spiral flutes connected to each of the two cutting edges, in which the two spiral flutes are joined together into a single flute at a position retreated by a predetermined amount from the front end of the body.

However, in the drill having the two flutes thus joined together, the chips generated from each of the cutting edges are liable to be clogged at a joining location of the two flutes. Consequently, due to heat generated at the joining location caused by the clogged chips, a workpiece is likely to be altered, and the inner wall of a drilled hole is likely to be deformed (surface roughness is likely to deteriorate). Further, the chips clogged at the joining location of the flutes may increase the stress (cutting torque) exerted on the joining location during machining, thus causing a fracture of the drill. On the other hand, the two flutes cross each other at the joining portion of the flutes, thus causing a change in the flute shape. Therefore, the flow of the chips passing through the individual flutes may be changed at the joining location, thus ruining the inner wall of the drilled hole.

Hence, there are a need for a drill having both excellent drilling performance and excellent fracture resistance, and a need for a method of manufacturing a machined product using the drill.

### SUMMARY OF THE INVENTION

A drill according to an embodiment of the present invention includes a body part and a cutting part with a cylinder-like shape. The cutting part includes two cutting edges located separately from each other at a front end portion of the cutting part, two flutes which are continuous with each of the two cutting edges and extend spirally toward a rear end portion of the cutting part, and a clearance which extends spirally from a side of the front end portion to a side of the rear end portion, and is recessed inward in reference to a periphery of the cutting part in a sectional view. The cutting part includes a first joining flute including at least one of the two flutes and the clearance being joined together. The first joining flute includes a bottom surface having a curve-like line protruding outwardly in a sectional view.

A drill according to other embodiment of the present invention includes a body part and a cutting part with a cylinder-like shape. The cutting part includes two cutting edges located separately from each other at a front end portion of the cutting part, and two flutes which are continuous with each of the two cutting edges and extend spirally toward a rear end portion of the cutting part and join together. Both of the two flutes reach a bottom part while having a larger depth D in reference to a periphery of the cutting part as the two flutes separate from one end thereof at a side of the front end portion than on a joining location in a sectional view. The depth D is smaller as going from the bottom part to the other end of the two flutes. The cutting part includes a first joining flute located closer to the rear end portion than the joining location. The first joining flute includes a bottom surface having a curve-like line protruding outwardly in a sectional view.

A method of manufacturing a machined product according to an embodiment of the present invention includes: rotating the drill around a rotation axis; bringing the two cutting edges of the drill being rotated into contact against a workpiece; and separating the workpiece and the drill from each other.

In the drills of the individual embodiments of the present invention, the first joining flute is obtained by joining the flutes and the clearance. It is therefore capable of reducing a situation that the chips discharged through the individual flutes are clogged at the joining location, while ensuring a large core thickness (inscribed circle) of the drill. This allows for both excellent drilling performance and excellent fracture resistance.

### BRIEF DESCRIPTION OF THE DRAWINGS

FIG. 1(a) is a general side view showing a drill according to an embodiment of the present invention; FIG. 1(b) is a side view showing in enlarged dimension a cutting part thereof;

FIG. 2(a) is a side view showing in enlarged dimension the cutting part of the drill shown in FIG. 1;

FIG. 2(b) is a front end view thereof;

FIG. 3(a) is a sectional view taken along the line X1-X1 in the drill shown in FIG. 1; FIG. 3(b) is a sectional view taken along the line X2-X2 in the drill shown in FIG. 1; FIG. 3(c) is a sectional view taken along the line X3-X3 in the drill shown in FIG. 1; FIG. 3(d) is a sectional view taken along the line X4-X4 in the drill shown in FIG. 1; and

FIG. 4(a) is a drawing for explaining a method of manufacturing a machined product according to an embodiment of the present invention, specifically illustrating the step of bringing the drill near a workpiece in Y direction; FIG. 4(b) is a drawing illustrating the step of bringing the drill into contact against the workpiece; and FIG. 4(c) is a drawing illustrating the step of separating the drill from the workpiece in Z direction.

### PREFERRED EMBODIMENTS FOR CARRYING OUT THE INVENTION

### Drill

### First Embodiment

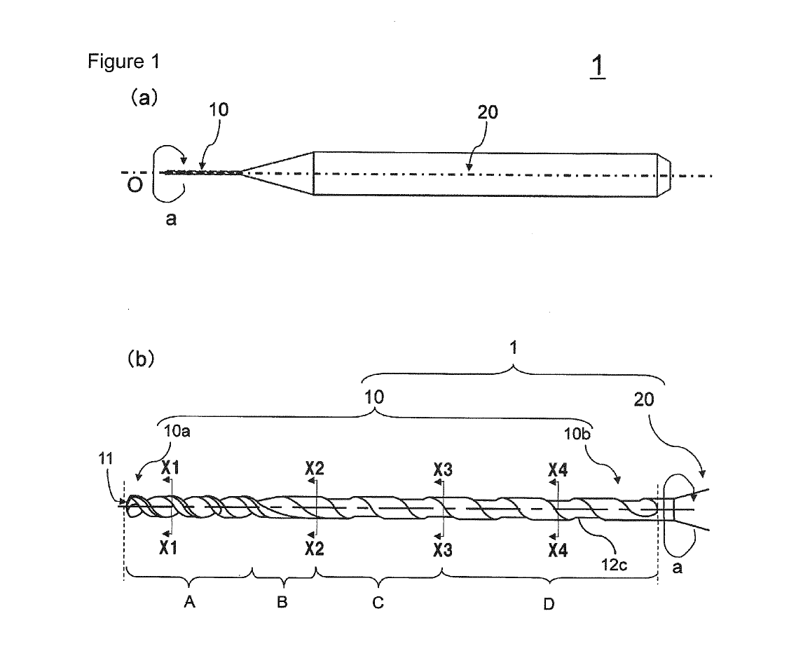

A first embodiment of the drill of the present invention is described below in details with reference to FIGS. 1 to 3.

As shown in FIG. 1, the drill 1 of the present embodiment includes a body part 20 configured to be held by a rotary shaft of a machine tool, and a cutting part 10 disposed on one end side of the body part 20. The body part 20 is designed according to the shape of the rotary shaft of the machine tool. The cutting part 10 is contacted against a workpiece 30.

The cutting part 10 has a major role in a cutting process for the workpiece 30, and has a cylinder-like shape in the present embodiment. That is, the cutting part 10 has a relationship of T1=T2, where T1 is a diameter in a front end portion 10a, and T2 is a diameter in portions other than the front end portion 10a. The cutting part 10 has also a constant diameter from the front end portion 10a to a rear end portion 10b in a cross section perpendicular to a rotation axis O.

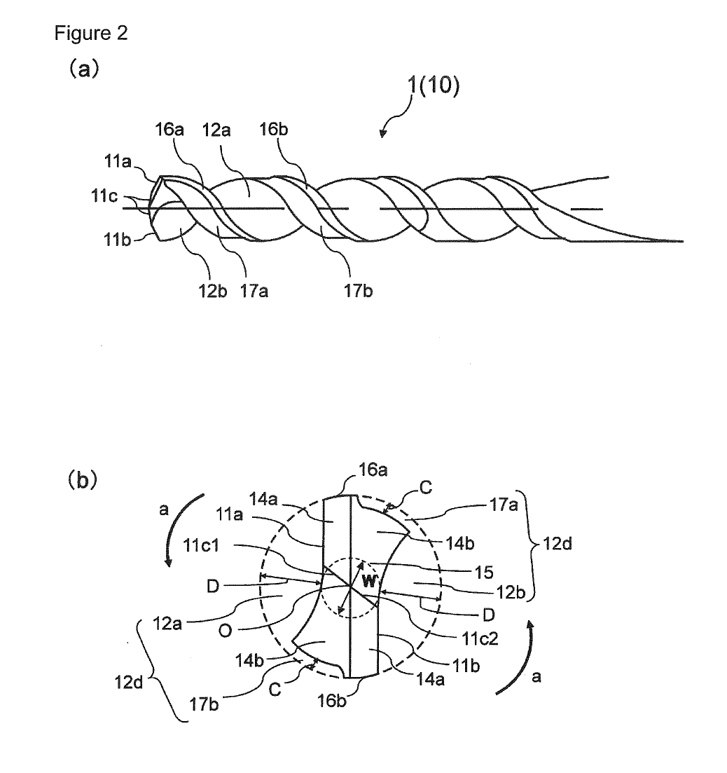

As shown in FIG. 2, two cutting edges 11 (first cutting edge 11a and second cutting edge 11b) are formed at the front end portion 10a of the cutting part 10. The first cutting edge 11a and the second cutting edge 11b are located to have 180-degree rotational symmetry in reference to the rotation axis O (axis) of the cutting part 10. That is, the first cutting edge 11a and the second cutting edge 11b have dyad symmetry with respect to the rotation axis O. This arrangement allows for improvement of straight travel stability when the workpiece 30 is machined.

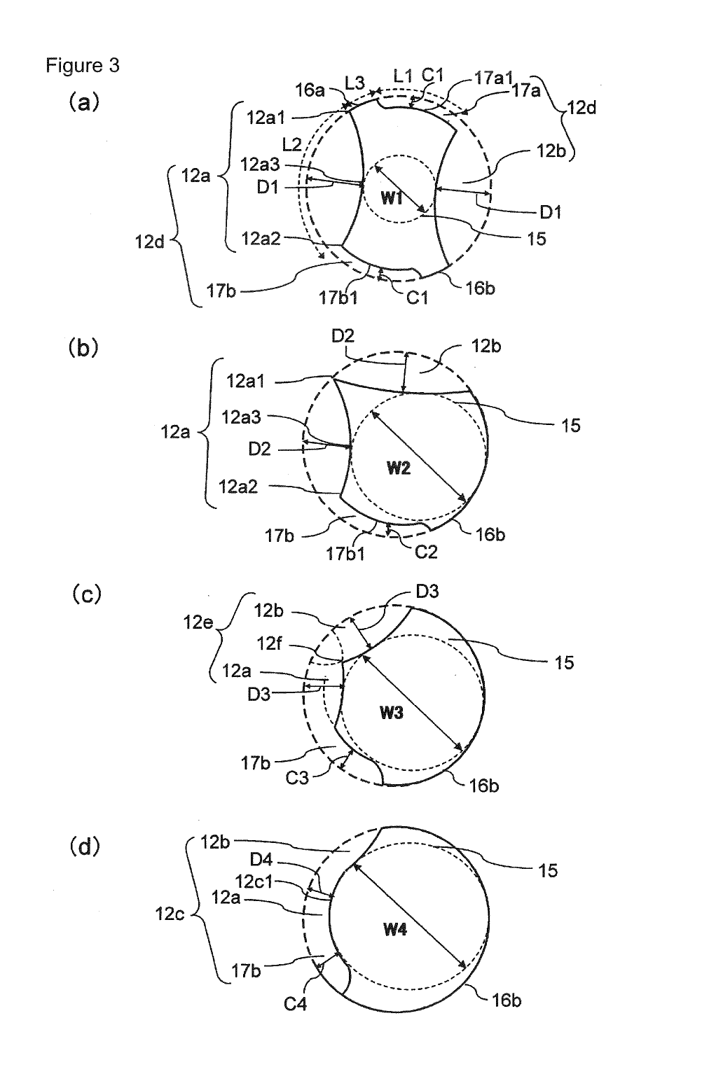

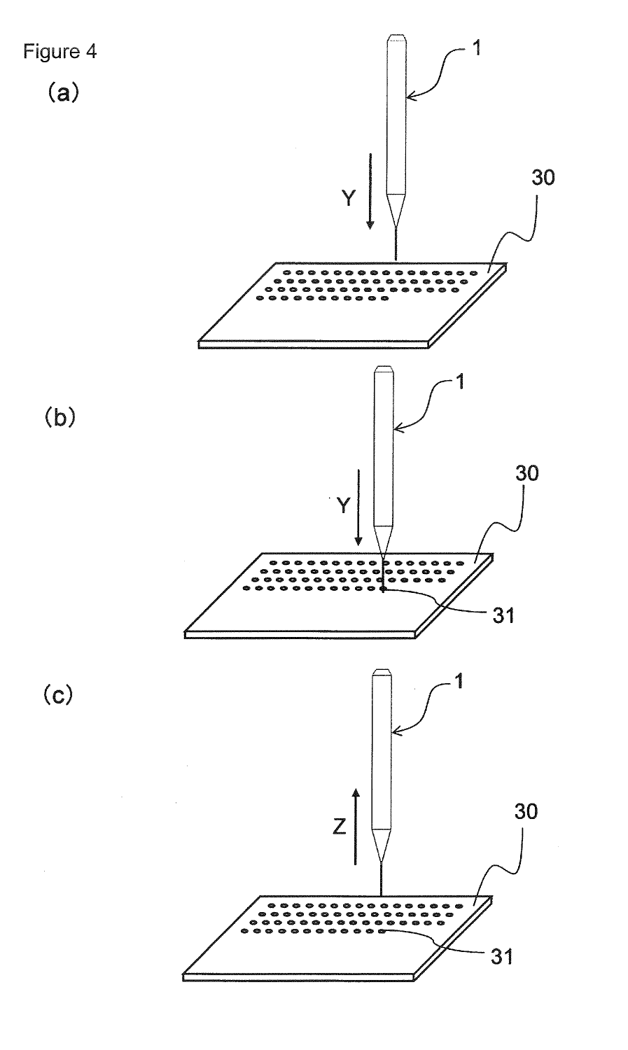

Two flutes 12 (first flute 12a and second flute 12b), whose main purpose is to discharge chips generated from the two cutting edges 11, correspond to the two cutting edges 11, and are formed spirally along the rotation axis O around the periphery of the cutting part 10. Specifically, the first flute 12a and the second flute 12b are continuous with each of the first cutting edge 11a and the second cutting edge 11b, and are located spirally from the front end portion 10a to the rear end portion 10b (closer to the body part 20) in the cutting part 10. In the present specification, the term “periphery” of the cutting part 10 denotes a region indicated by a dotted line in FIG. 2(b) and FIG. 3. Alternatively, the first flute 12a and the second flute 12b may be continuous with each of the first cutting edge 11a and the second cutting edge 11b via another element, such as flank surfaces 14 described later.

In the present embodiment, as shown in FIG. 2, chisel edges 11 (11c1 and 11c2) are located closest to the front end portion 10a of the cutting part 10. Both the first cutting edge 11a and the second cutting edge 11b have a role in cutting the workpiece 30.

According to the drill 1 of the present embodiment having the foregoing basic configuration, the chips generated by the first cutting edge 11a during the cutting process are discharged to the rear end portion 10b via the first flute 12a continuous with the first cutting edge 11a, and the chips generated by the second cutting edge 11b are discharged to the rear end portion 10b via the second flute 12b continuous with the second cutting edge 11a. That is, the chips generated by the cutting edges 11 are separately discharged to the rear end portion 10b via their corresponding flutes 12. The chips generated by the chisel edge 11c1 continuous with the first cutting edge 11a and the chips generated by the chisel edge 11c2 continuous with the second cutting edge 11b flow through correspondingly located second flank surfaces 14b, and are then discharged to the rear end portion 10b via the first flute 12a and the second flute 12b, respectively. Arrows a indicate a rotation direction of the drill 1.

As shown in FIGS. 2 and 3, the drill 1 of the present embodiment has a clearance 17 in a region of the front end portion 10a of the cutting part 10 except for the cutting edges 11. The clearance 17 is recessed inward in reference to the periphery of the cutting part 10 in a front end view or sectional view. In the present specification, the phrase “sectional view” denotes a cross section perpendicular to the rotation axis O. In the present embodiment, the clearance 17 includes a bottom surface having a curve-like line or an arc-like shape. The clearance 17 extends from the front end portion 10a to a region closer to the rear end portion 10b. The arc-like shape of the clearance 17 is preferably identical to a radius of curvature of the cutting part 10. The clearance 17 has a function of reducing contact between the drill 1 and an inner wall of a machined hole 31 of the workpiece 30, and can contribute to the improvement of chip discharge performance. A drill diameter (outer diameter) corresponds to a size of the cutting part 10 before forming the clearance 17. In the present embodiment, as shown in FIG. 2(b), two clearances 17a and 17b exist in the front end portion 10a, and the two flutes 12 and the two clearances 17 are respectively joined together at least partially to form a second joining flute 12d. In the present specification, the phrase “joined together at least partially” denotes a state that two elements or regions are not completely joined together, and are partially integrated in a range in which their own characteristics and purposes can be produced individually. For example, a partial joint between the first flute 12a and the second flute 12b denotes a state that in spite of an integrated portion, a flute wall surface located between the first and second flutes 12a and 12b maintains a sufficient height to prevent intercommunication of the chips discharged through the inside of each of the first and second flutes 12a and 12b.

As shown in FIGS. 2(b) and 3, a distance C from the periphery to bottom surfaces (17a1 and 17b1) of the clearances 17 is preferably larger at a side of the rear end portion 10b than at a side of the front end portion 10a in a sectional view. The distance C is preferably largest in the first joining flute 12c. The distance C may be changed stepwise on a predetermined section basis, or may be changed continuously gently. Alternatively, the distance C may be smallest between the side of the front end portion 10a and the side of the rear end portion 10b. Thus, owing to the distance C that is larger at the side of the rear end portion 10b than at the side of the front end portion 10a, when the first joining flute 12c is made up of the clearance 17 and the first and second flutes 12a and 12b, a bottom surface 12c1 of the first joining flute 12c can be relatively easily formed into a curve-like line outwardly protruding or an arc-like shape by changing the distance C of the clearances 17 with the bottom surfaces having the curve-like line shape or the arc-like shape. A depth D from the periphery of the two flutes 12 in a sectional view is preferably smaller at the side of the rear end portion 10b than at the side of the front end portion 10a according to the change in the distance C of the clearance 17.

As shown in FIG. 3(a), a width L1 of the clearances 17 can be made larger at the side of the rear end portion 10b than at the side of the front end portion 10a in a sectional view. The width of the clearances 17 does not means a length of the bottom surfaces 17a1 or 17b1, but means a corresponding peripheral length as shown in FIG. 3(a). That is, in the present specification, the term “width” denotes a length of an arc-like line segment along the periphery (refer to FIG. 3(a)). A width of the first clearance 17a denotes a corresponding peripheral opening length. As described later, when two elements or regions are not independent, specifically when the first clearance 17a and the second flute 12b are partially joined together as shown in FIG. 3(a), the width of the two may be determined using a normal line of the periphery corresponding to a joining point therebetween. The width L1 of the clearances 17 is preferably smaller than a width L2 of each of the two flutes 12 at a side closer to the front end portion 10a than the first joining flute 12c in a sectional view. Further, the width L2 of the two flutes 12 in a sectional view is preferably smaller at the side of the rear end portion 10b than at the side of the front end portion 10a.

The cutting part 10 has margins 16 in a region where neither the clearance 17 nor the flutes 12 are present. The margins 16 are respectively a region corresponding to the periphery of the cutting part 10, and have an arc-like shape in a sectional view. In the present embodiment, as shown in FIG. 2(b), in the front end portion 10a, a first margin 16a is located between the first flute 12a and the first clearance 17a, and a second margin 16b is located between the second flute 12b and the second clearance 17b. As shown in FIG. 3, the first margin 16a is reduced to zero and a length L3 of the second margin 16b is increased as going toward the rear end portion 10b. The margins 16 of the present embodiment extend from the side of the front end portion 10a to the side of the rear end portion 10b, and a width L3b at the side of the rear end portion 10b is larger than a width L3a at the side of the front end portion 10a. This allows for the improvement of the strength of the drill 1. The width L3 of the margins 16 is a region shown in FIG. 3(a). The width L3a at the side of the front end portion 10a and the width L3b at the side of the rear end portion 10b in the region are concepts that indicate a relative positional relationship between the front and rear end portions in the cutting part 10, and cannot be clearly divided in reference to a predetermined position.

In the present embodiment, at least one of the flutes 12 (first flute 12a and second flute 12b) and the clearances 17 are joined together to form the first joining flute 12c with the bottom surface 12c1 having the curve-like line protruding outwardly in a sectional view. The flutes 12 and the clearances 17 are independent from each other or partially joined together at the side closer to the front end portion 10a, but they form the first joining flute 12c at a predetermined location closer to the rear end portion 10b. In the present specification, the term “joining” denotes a situation that two or more elements or regions are integrated with each other to the degree to which they do not perform independently their major feature or function. For example, in the joining of the first flute 12a and the second flute 12b, a flute wall surface located therebetween is lowered by advanced integration, thus allowing for intercommunication of the chips discharged through the inside of each of the two flutes. Examples of this are the case where a convex-like boundary portion 12f described later is less than 50% with respect to the depth D from the periphery of the flutes 12, and the case where an interior angle formed by an end portion of the first flute 12a and an end portion of the second flute 12b is an obtuse angle. Specific configurations of regions A to D in the cutting part 10 as shown in FIG. 1(b) are described below in order.

Firstly, in the region A, the two flutes 12 are separated from each other, and the two flutes 12 and the two clearances 17 are respectively partially joined together to form two second joining flutes 12d (refer to FIGS. 2(b) and 3(a)). That is, in the present embodiment, as shown in FIGS. 2(b) and 3(a), in the front end portion 10a of the cutting part 10, the first flute 12a and the second clearance 17b are partially joined together to form the second joining flute 12d, and the second flute 12b and the first clearance 17a are partially joined together to form the second joining flute 12d. In the region A, the distance C1 from the periphery to the bottom surface of the clearance 17 is smaller than the depth D1 in reference to the periphery of the flute 12 as described above.

In the region B, the mutual distance between the two flutes 12 is changed. In the present embodiment, a helix angle of the first flute 12a is constant and a helix angle of the second flute 12b is decreased. Consequently, the distance between the two is changed in such a manner that the second flute 12b is relatively brought close to the first flute 12a. FIG. 3(b) is a sectional view showing a boundary region between the region B and the region C, specifically showing a state that an end portion of the first flute 12a and an end portion of the second flute 12b are continuous with each other by the foregoing mutual distance change between the two flutes 12. As another example, both helix angles of the two flutes 12 may be changed. In the present embodiment, in the region B, the distance C2 from the periphery of the bottom surface of the clearance 17 is increased as going toward the rear end portion 10b, and the depth D2 in reference to the periphery of the flutes 12 is decreased as going toward the rear end portion 10b.

In the region C, the mutual distance change between the two flutes 12 in the region B is advanced to allow the two flutes 12 to be partially joined together to form a third joining flute 12e. FIG. 3(c) is a sectional view showing a boundary region between the region C and the region D, specifically showing a state that a convex-like boundary portion 12f exists between the first flute 12a and the second flute 12b. The convex-like boundary portion 12f preferably has a predetermined height with respect to a portion of the first flute 12a and the second flute 12b which has the largest depth D in reference to the periphery. This allows for a smooth chip discharge without mutual interference of the chips flowing through the inside of the first flute 12a and the inside of the second flute 12b. In the present embodiment, also in the region C, the distance C from the periphery of the bottom surface of the clearance 17 is increased as going toward the rear end portion 10b, and a depth D3 in reference to the periphery of the flutes 12 is decreased as going toward the rear end portion 10b.

In the region D, the third joining flute 12e, which is formed by joining the two flutes 12, is further joined together with the clearances 17 to form a first joining flute 12c with a bottom surface 12c1 having a curve-like line protruding outwardly in a sectional view (refer to FIG. 3(d)). In the present embodiment, a distance C4 from the periphery to the bottom surface of the clearance 17 is larger than a depth D4 in reference to the periphery of the flutes 12. Consequently, the bottom surface 12c1 of the first joining flute 12c has the curve-like line protruding outwardly in the sectional view.

Thus, in the first joining flute 12c formed by joining the flutes 12 and the clearances 17, the bottom surface 12c1 having the curve-like line protruding outwardly in the sectional view. It is therefore capable of reducing the situation that the chips discharged through the individual flutes 12 are clogged at the joining locations, while ensuring the dimension of a core thickness (inscribed circle diameter) W of the drill 1. This allows for both excellent drilling performance and excellent fracture resistance. That is, it is capable of reducing the situation that the heat generated from the chip-clogged locations causes the alteration of the workpiece 30 and the deformation of the inner wall of the drilled hole 31 (the deterioration of surface roughness) as occurred with the conventional technology. It is also capable of reducing the situation that the drill is broken due to increased stress on the chip-clogged locations. Although the shape of the flutes or the like is changed according to the joining of the flutes 12 and the clearances 17, the curve-like line protruding outwardly of the bottom surface 12c1 allows for a smooth change in the flow of the chips passing through the individual flutes 12. This makes it possible to reduce the situation that the disturbed chip flow ruins the inner wall of the drilled hole 31. In the present specification, the phrase “inscribed circle” denotes a maximum circle that can be formed in the cutting part 10 in the cross section perpendicular to the central axis O. The diameter W of an inscribed circle 15 corresponds to a cross-sectional core thickness of the drill which becomes an index to measure the rigidity of the drill. Therefore, a larger diameter W indicates higher rigidity of the drill. In the present embodiment, as shown in FIGS. 2(b) and 3, the diameter W of the inscribed circle 15 in the cross section perpendicular to the rotational axis O of the cutting part 10 is increased as going from the front end portion 10a toward the rear end portion 10b. That is, the cutting part 10 has a relationship of Wa<Wb, where Wa is a diameter of the inscribed circle 15 located closer to the front end portion 10a, and Wb is a diameter of the inscribed circle 15 located closer to the rear end portion 10b. Hence, the cross-sectional core thickness of the drill is increased as going toward the rear end portion 10b, thus allowing the drill to have high rigidity. Although the center of the inscribed circle 15 in the vicinity of the front end portion 10a is located at the same position as the rotational axis O, this is not necessarily true for portions other than the vicinity of the front end portion 10a. More specifically, the present embodiment has a relationship of W1<W2<W3<W4, as shown in FIG. 3.

This operation advantage is remarkable when the workpiece 30 is a resin substrate with low heat resistance, or a composite substrate using the resin substrate, or the like. An example of the composite substrate is a printed circuit board having copper foil laminated on a glass epoxy material in which glass fiber is impregnated with resin, such as epoxy. If a smooth chip discharge cannot be performed when the printed circuit board is drilled out, the chips of the copper foil can damage the inner wall of the drilled hole 31, and cutting heat is stored inside the drilled hole 31 without being smoothly released to the outside. Consequently, there is a risk that the resin is softened to increase the inner surface roughness of the drilled hole 31 (the inner wall roughness is deteriorated). However, the drill 1 of the present embodiment that provides the foregoing operation effect is suitably applicable to the printed circuit board because the drill 1 can also decrease the inner surface roughness of the printed circuit board.

The drill 1 of the present embodiment is suitably used as a small diameter drill with the cutting edges 11 having an outer diameter of 0.6 mm or less, preferably 0.3 mm or less, or as a drill for deep drilling. The drill 1 is particularly suitable for drilling the workpiece 30 susceptible to thermal damage. The drill 1 of the present embodiment is suitably used for deep drilling in which, for example, L/D is 5 or more, where L is an axial length (a length from the cutting edge 11 to the termination of the flute 12), and D is a diameter (an outer diameter of the cutting edge 11).

### Second Embodiment

A drill according to a second embodiment of the present invention is described below. The basic configuration thereof is similar to that of the drill of the first embodiment, and therefore, the description is made by properly referring to FIGS. 1 to 3.

The drill 1 according to the present embodiment includes a cutting part with a cylinder-like shape 10 and a body part 20. The cutting part 10 has at a front end portion 10a thereof two cutting edges 11a and 11b located separately from each other, and two flutes 12a and 12b which are continuous with each of the two cutting edges 11a and 11b, and extend spirally toward a rear end portion 10b of the cutting part 10 until both join together. Both of the two flutes 12 and 12b reach a bottom portion 12a3 while having a larger depth from the periphery of the cutting part 10 as they separate from one end portion 12a1 in a sectional view. Both of the two flutes 12a and 12b have a smaller depth as going from the bottom portion 12a3 to the other end portion 12a2. The cutting part includes a first joining flute 12 located closer to the rear end portion 10b than a joining location. The first joining flute 12C includes a bottom surface 12c1 having a curve-like line protruding outwardly in a sectional view. The phrase “bottom part” denotes the part having the largest depth from the periphery of the cutting part 10. In the present embodiment, the bottom part is a point having no predetermined length.

Thus, the present embodiment includes the first joining flute 12c with the outwardly protruding bottom surface 12c1 similarly to the first embodiment by joining the two flutes 12a and 12b recessed inwardly with respect to the periphery, without including the clearance 17 as in the first embodiment. This configuration is achieved by changing, for example, the shapes of the two flutes 12a and 12b as they go from the front end portion 10a to the rear end portion 10b, particularly by changing the bottom surface shape thereof. As other examples, the curve-like line protruding outwardly without the foregoing convex-like boundary portion 12f can be made by forming a third flute (not shown) from a side closer to the front end portion 10a than the first joining flute 12c toward the rear end portion 10b, and by allowing the third flute to join together with the first flute 12a and the second flute 12b, or by interposing the third flute between the first flute 12fa and the second flute 12b in a third joining flute 12e.

The drill 1 having the configuration of the present embodiment can also provide an operation effect similar to that of the drill 1 of the foregoing first embodiment.

Other configurations are similar to those in the drill 1 of the foregoing first embodiment, and therefore the descriptions thereof are omitted here. That is, as the configuration whose description is omitted here, a configuration similar to that of the drill 1 of the first embodiment can suitably be employed.

The drill of each of the foregoing embodiments is used by inserting the body part 20 located closer to the rear end portion 10b of the cutting part 10 into a drill holding part of a machine tool. No particular limitation is imposed on the machine tool insofar as usually used by those skilled in the art. Examples of the machine tool include various kinds of machines, such as machining centers. The drill attached to the machine tool is firstly rotated around the rotation axis O in the direction of the arrow a. Next, the drill being rotated is fed forward in the rotation axis O, and is then pressed against, for example, the workpiece 30. Thus, the drilled hole 31 having a predetermined inner diameter can be formed in the workpiece 30. This is described in detail later.

### <Method of Manufacturing Machined Product>

An embodiment of the method of manufacturing a machined product according to the present invention is described in detail below by illustrating the case of using the drill 1 according to the foregoing first embodiment.

The method of manufacturing a machined product according to the present embodiment includes the following steps (i) to (iv).

(i) Disposing the drill 1 above the workpiece 30

(ii) Bringing the drill 1 near the workpiece 30 by rotating the drill 1 in the direction of the arrow a around the rotation axis O

This step is carried out for example by fixing the workpiece 30 onto a table of a machine tool having the drill 1 attached thereto, and by bringing the drill 1 being rotated near the workpiece 30. In this step, the workpiece 30 and the drill 1 may be brought near each other. For example, the workpiece 30 may be brought near the drill 1.

(iii) Forming a drilled hole 31 in the workpiece 30 by bringing the drill 1 nearer the workpiece 30 so that the first cutting edge 11a and the second cutting edge 11b of the drill 1 being rotated are contacted against a desired position of the surface of the workpiece 30

In this step, machining conditions are preferably set so that a partial region of the cutting part 10 of the drill 1 closer to the rear end portion 10b does not pass through or does not contact against the workpiece 30, from the viewpoint of obtaining a satisfactory machined surface. That is, when chips pass through the flutes 12 formed in the partial region, the contact between the chips and the workpiece 30 is reduced to allow for excellent chip discharge performance.

(iv) Separating the drill 1 from the workpiece 30

In this step, the workpiece 30 and the drill 1 may be separated from each other similarly to the above step (ii). For example, the workpiece 30 may be separated from the drill 1.

Excellent drilling performance is achieved by performing the foregoing individual steps. As described earlier, the drill 1 is capable of reducing the situation that the chips discharged through the individual flutes are clogged at the joining locations, while ensuring the core thickness of the drill 1. Therefore, the drill 1 achieves both excellent drilling performance and excellent fracture resistance, thereby allowing the workpiece 30 to be stably cut over a long term.

When the machining of the workpiece 30 as described above is carried out a plurality of times, specifically, when a plurality of drilled holes 31 are formed in the single workpiece 30, it is required to repeat the step of bringing the first cutting edge 11a and the second cutting edge 11b of the drill 1 into contact against different locations of the workpiece 30, while keeping the drill 1 rotating.

With the method of manufacturing the machined product according to the present embodiment, the high quality drilled hole 31 is also obtainable with respect to the workpiece 30 with low heat resistance for the above reason.

Specific examples of the workpiece 30 with the low heat resistance include the foregoing printed circuit board and the like. In this case, the step (i) of preparing the workpiece 30 preferably includes laminating a plurality of boards having a conductor composed of copper and the like being pattern-formed on their respective surfaces, while interposing between the boards an intermediate layer containing a resin material; and softening the resin material by heating the intermediate layer. The intermediate layer is preferably one which is obtained by impregnating the resin material into a glass cloth, from the viewpoint of reinforcing the boards as the workpiece 30, and also retaining insulation between the boards. Accordingly, by pressing under temperature conditions of for example 200° C. or above, the resin material of the intermediate layer is softened, and the boards having surface irregularities are laminated one upon another with no clearance therebetween, thereby forming the workpiece 30.

When the workpiece 30 contains glass, powder glass as part of chips has viscosity or is melted by the heat generated due to chip clogging or the like. Hence, there is a tendency to further deteriorate chip discharge performance. With the method of manufacturing the machined product using the drill 1 of the present embodiment, it is also capable of achieving excellent chip discharge performance with respect to this workpiece 30.

While the several embodiments of the present invention have been described and illustrated above, the present invention is not limited to the foregoing embodiments. Needless to say, it is possible to make optional ones insofar as they do not depart from the gist of the present invention.

For example, the foregoing embodiments are configured to include the two flutes 12a and 12b and the two clearances 17a and 17b. Alternatively, they may include the single clearance 17 with respect to the two flutes 12a and 12b.

The foregoing embodiments are configured to dispose the clearances 17 at the front end portion 10a of the cutting part 10. Alternatively, the clearances 17 may be formed from a middle portion of the cutting part 10 to a side of the rear end portion 10b.

In the foregoing embodiments, the inscribed circle diameter (core thickness) W is largest in the portion of the cutting part 10 where the first joining flute 12c is formed. Alternatively, the inscribed circle diameter may be larger at a side closer to the rear end portion 10b than the first joining flute 12c.

The shape of the cutting part 10 may be those normally employed by those skilled in the art without being limited to the configurations in the foregoing embodiments. For example, the cutting part 10 may have such a tapered shape that the core thickness W increases from the front end portion 10a toward the rear end portion 10b. Alternatively, the cutting part 10 may be inclined so that the drill diameter (outer diameter) increases or decreases from the front end portion 10a toward the rear end portion 10b. Further, the cutting part 10 may include an undercut portion.

1. A drill, comprising:
a body part; and
a cutting part with a cylinder-like shape,
the cutting part comprising
two cutting edges located separately from each other at a front end portion of the cutting part,
two flutes which are continuous with each of the two cutting edges and extend spirally toward a rear end portion of the cutting part, and
a clearance which extends spirally from a side of the front end portion to a side of the rear end portion, and is recessed inward in reference to a periphery of the cutting part in a sectional view, wherein
the cutting part comprises a first joining flute comprising at least one of the two flutes and the clearance being joined together, the first joining flute comprising a bottom surface having a curve-like line protruding outwardly in a sectional view.

2. The drill according to claim 1, wherein the bottom surface of the first joining flute has an arc-like shape protruding outwardly in a sectional view.

3. The drill according to claim 1, wherein the cutting part further comprises a second joining flute located closer to the front end portion than the first joining flute, the second joining flute comprising one of the two flutes and the clearance being at least partially joined together.

4. The drill according to claim 3, wherein the first joining flute is a flute comprising the other of the two flutes and the second joining flute being joined together.

5. The drill according to claim 1, wherein
the cutting part further comprises a third joining flute located closer to the front end portion than the first joining flute, the third joining flute comprising the two flutes being joined together.

6. The drill according to claim 5, wherein the first joining flute is a flute comprising the third joining flute and the clearance being jointed together.

7. The drill according to claim 1, wherein a distance C from the periphery to a bottom surface of the clearance is larger at the side of the rear end portion than at the side of the front end portion in a sectional view.

8. The drill according to claim 1, wherein the distance C from the periphery to the bottom surface of the clearance is largest in a region of the first joining flute in a sectional view.

9. The drill according to claim 1, wherein a depth D of the two flutes in reference to the periphery is smaller at the side of the rear end portion than at the side of the front end portion in a sectional view.

10. The drill according to claim 1, wherein the distance C from the periphery to the bottom surface of the clearance is larger than the depth D of the two flutes in reference to the periphery at the side of the rear end portion in a sectional view.

11. The drill according to claim 1, wherein a width L1 of the clearance is larger at the side of the rear end portion than at the side of the front end portion in a sectional view.

12. The drill according to claim 1, wherein the width L1 of the clearance is smaller than a width L2 of each of the two flutes in a region closer to the side of the front end portion than the first joining flute in a sectional view.

13. The drill according to claim 1, wherein the width L2 of the two flutes is smaller at the side of the rear end portion than at the side of the front end portion in a sectional view.

14. The drill according to claim 1, wherein the cutting part has the largest core thickness W in a region where the first joining flute is located.

15. The drill according to claim 1, wherein the cutting part further comprises a margin located at the periphery in a sectional view.

16. The drill according to claim 15, wherein
the margin extends from the side of the front end portion to the side of the rear end portion, and
a width L3b at the side of the rear end portion is larger than a width L3a at the side of the front end portion in a sectional view.

17. A drill, comprising:
a body part; and
a cutting part with a cylinder-like shape,
the cutting part comprising
two cutting edges located separately from each other at a front end portion of the cutting part, and
two flutes which are continuous with the two cutting edges, respectively, and extend spirally toward a rear end portion of the cutting part and join together, wherein
both of the two flutes reach a bottom part thereof while a depth D in reference to a periphery of the cutting part being larger in a sectional view as the two flutes separate from one end thereof, and the depth D being smaller in a sectional view as going from the bottom part to the other end thereof, in a region closer to a side of the front end portion than a location the two flutes joined, and
the cutting part comprises a first joining flute located closer to the rear end portion than the location, the first joining flute comprising a bottom surface having a curve-like line protruding outwardly in a sectional view.

18. The drill according to claim 17, wherein the bottom surface of the first joining flute has an arc-like shape protruding outwardly in a sectional view.

19. A method of manufacturing a machined product, comprising:
rotating a drill according to claim 1 around a rotation axis;
bringing the two cutting edges of the drill being rotated into contact against a workpiece; and
separating the workpiece and the drill from each other.
